(19) United States
(12) Patent Application Publication
(10) Pub. No.: US 2007/0005898 A1
(43) Pub. Date: Jan. 4, 2007

(54) Method, apparatus and system for task context cache replacement

(76) Inventors: William Halleck, Lancaster, MA (US); Pak-lung Seto, Shrewsbury, MA (US); Victor Lau, Marlboro, MA (US); Naichih Chang, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/170,872

(22) Filed: Jun. 30, 2005

(51) Int. Cl. G06F 12/00; G06F 12/14

(52) U.S. Cl. 711/129; 711/163

(57) ABSTRACT

A device includes a cache memory having a locked segment and an unlocked segment. A controller is connected to the cache memory. A method partitions a cache memory into context segments and associates a context entry with at least one of the context segments if a transport layer completes processing a frame for the context entry. The at least one segment is an unlocked context segment.

### BACKGROUND

1. Field

The embodiments relate to context cache replacement, and more particularly to segmenting context cache into multiple segments.

2. Description of the Related Art

In packetized protocol engine design, e.g., hardware storage, etc., processing of transmit and receive tasks requires the use of data structures called “task” or “I/O” context. The task context contains information for processing frames within a particular input/output (I/O) task and hardware status that allows the transport layer to resume a task that has been interleaved with other tasks. If the hardware packetized protocol engine is designed to support a large number of outstanding I/O tasks, a large context memory (e.g., random access memory (RAM)) is required (either on-chip or through an external memory interface).

To keep costs low, these designs typically trade off footprint space for memory latency, resulting in a performance penalty during context switching. To try to avoid the tradeoff, a packetized protocol engine design may implement a cache memory for storing commonly accessed task contexts locally.

If a context cache is implemented, a process for swapping out previously used contexts for newly requested contexts is needed. One common method for replacing these contexts is to remove the “least recently used” (LRU) entry. A design using LRU replacement waits for the transport layer to request a new context, then determines which context has not been accessed for the longest time period, and swaps the new context in for the one chosen for eviction.

There are some issues with using simple LRU in a packetized protocol engine. For example, assume two serial attached SCSI (small computer systems interface) (SAS) standard (e.g., Version 1.1, Revision 09d, May 30, 2005; SAS-1.1) lanes share a context cache that has space for only two contexts. The following occurs (see FIG. 1 100). Lane 0 110 requests context Cₓ. Cₓ is loaded from context memory 160 into the cache memory and the Lane 0 110 transport layer begins processing frame X 130. Lane 1 120 then requests context C_{y}. C_{y} is loaded into the cache memory and the Lane 1 transport layer 120 begins processing frame Y 140. Lane 1 120 completes processing frame Y 140, and updates context C_{y} by writing to the cache memory. Lane 1 120 requests context C_{z} to process the next frame, Z 150. Since context C_{y} was updated most recently, simple LRU would suggest that context Cₓ be evicted to make room for the new context. Since Lane 0 110 is still using context Cₓ to process frame X 130, this would not be the optimal choice.

Another example is the case where 2 lanes share a context cache. As illustrated in FIG. 2, the cache memory has space for four (4) contexts, and implements a mechanism to prevent contexts that are in use from being replaced. Lane 0 transport layer 210 requests context Cₓ. Cₓ is loaded from context memory 240 into the cache memory and Lane 0 transport layer 210 begins processing frame X 225. Lane 1 transport layer 220 requests context C_{y}. C_{y} is loaded into the cache memory and Lane 1 transport layer 220 begins processing frame Y 227. Lane 0 transport layer 210 indicates to the cache that context C_{z} will be needed soon (frame Z 226 is inbound on lane 0 transport layer 210). Context C_{z} is prefetched into the cache memory. Lane 1 transport layer 220 indicates to the cache memory that context Cᵥ will be needed soon (frame V 228 is inbound on Lane 1 transport layer 220). Context Cᵥ is prefetched into the cache memory.

Lane 1 transport layer 220 completes processing frame Y 227 and updates context C_{y} by writing to the cache memory. Lane 1 transport layer 220 begins processing frame V 228, which uses context Cᵥ. Lane 1 transport layer 220 indicates to the cache memory that context C_{w} will be needed soon (frame W 229 is inbound on Lane 1 transport layer 220). Since context Cₓ is owned by Lane 0 transport layer 210, it cannot be replaced. The next least recently used context is C_{z} (C_{y} was just updated and Cᵥ is also in use). However, it is not optimal to evict C_{z}, because it will be used soon (it was prefetched). LRU, in this example, is not an optimal choice.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates an example of a least recently used (LRU) cache context mechanism.

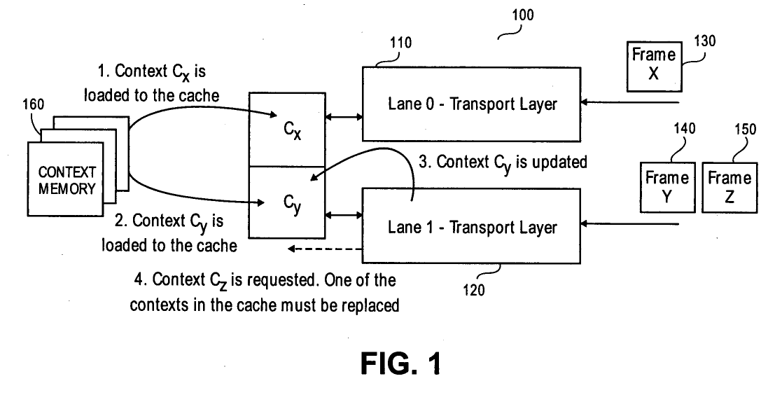

FIG. 2 illustrates another example of LRU cache context mechanism.

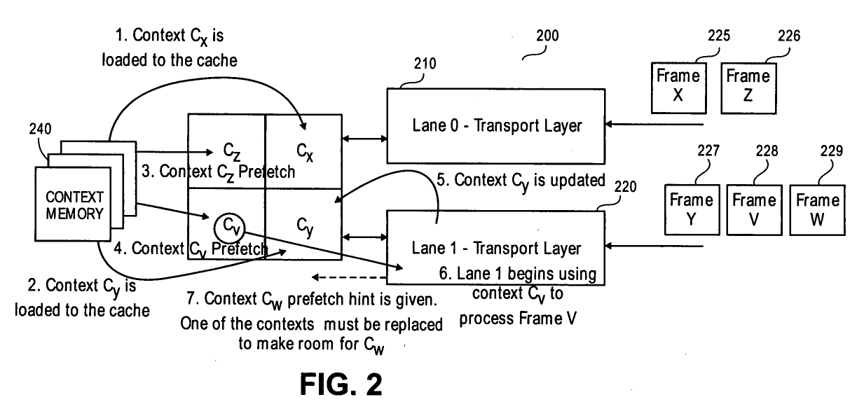

FIG. 3 illustrates an embodiment including cache context segments.

FIG. 4 illustrates a system of an embodiment.

FIG. 5 illustrates a block diagram of a process embodiment.

### DETAILED DESCRIPTION

The embodiments discussed herein generally relate to a method, system and apparatus for improving context cache efficiency. Referring to the figures, exemplary embodiments will now be described. The exemplary embodiments are provided to illustrate the embodiments and should not be construed as limiting the scope of the embodiments.

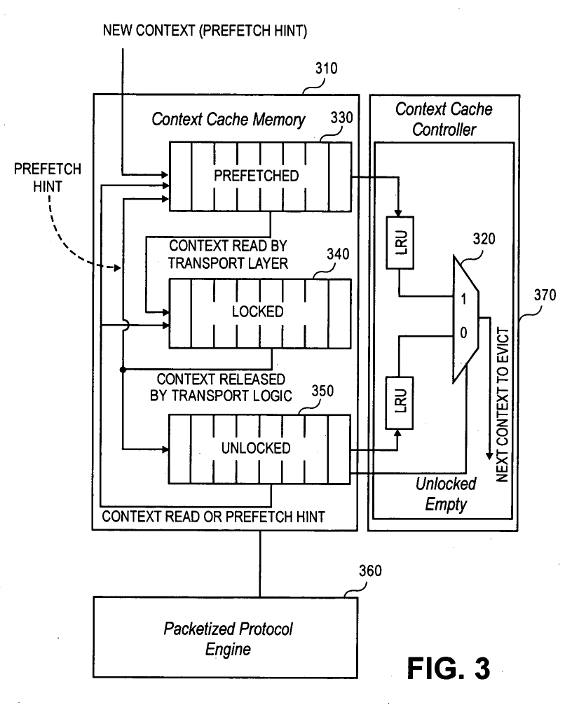

FIG. 3 illustrates an embodiment including cache (e.g., context cache) memory 310, packetized protocol, engine 360 and context cache controller 370. In one embodiment context cache controller includes logic switching device 320. In one embodiment cache memory 310 may be divided in a plurality of segments, e.g. segment 330, segment 340, segment 350, etc. to service different types of contexts (e.g., prefetched, locked, unlocked) in each segment. In one embodiment the segments may be formed by logically partitioning cache memory 310. In another embodiment, two or more cache memories can be used to service different types of contexts. In one embodiment a field is associated with each cache context entry indicating a logical value which defines the segment to which that entry belongs. In one embodiment segment 330 is a prefetched context segment, segment 340 is a locked context segment and segment 350 is an unlocked context segment. In one embodiment cache memory 310 does not include segment 330. In this embodiment, cache memory 310 is partitioned into two segments, segment 340 and segment 350.

Device 300 further includes packetized protocol engine 360 connected to cache memory 310. Packetized protocol engine 360 can be adapted for different types of protocols, such as storage protocols, input/output protocols, etc. It should be noted that segments 330, 340 and 350 may be associated with any of the three types of contexts. For simplicity, segment 330 is discussed below as prefetched context segment 330; segment 340 is discussed below as locked context segment 340; and segment 350 is discussed below as unlocked context segment 350.

As illustrated to above, in one embodiment, prefetched context segment 330, locked context segment 340 and unlocked context segment 350 are separate partitions in cache memory 310. In another embodiment segment 330, segment 340 and segment 350 are each associated with a logic state that distinguishes the three types of context segments, e.g. (00, 01, 10; 000, 010, 100, etc.).

In one embodiment prefetched context segment 330 supports inclusion of context hints from the transport layer or a logic process. In this embodiment prefetched contexts are likely to be used in the near future, and are not evicted from cache memory 310 unless there are no other valid candidates. In this embodiment, the hints include known contexts from a look-ahead device, such as a buffer. In one embodiment locked context segment 340 enables a context transport layer to mark a currently used context. In one embodiment the locked context segment 340 includes contexts that are currently in use by transport layer logic. The locked contexts are not replaced under any circumstances. Unlocked context segment 350 stores contexts that have been locked and subsequently released. The unlocked contexts are replaced first if memory space in cache memory 310 is needed. In yet another embodiment context cache controller 370 operates on unlocked context segment 350 with a least recently used (LRU) eviction process. It should be noted that other known eviction processes can be used as well.

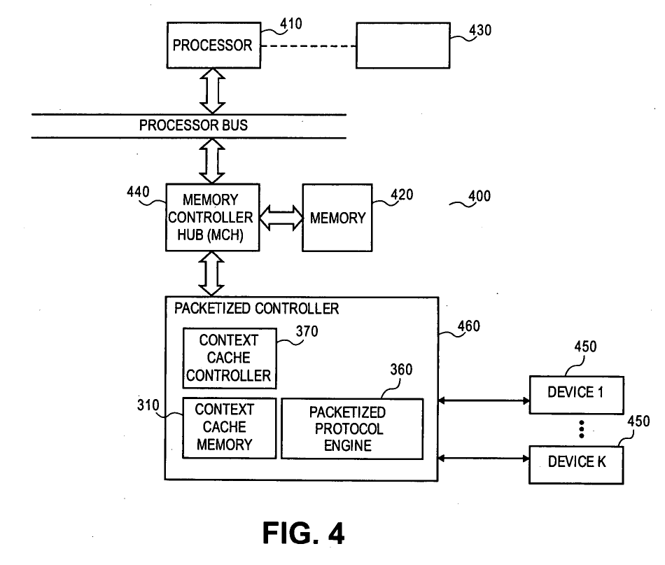

FIG. 4 illustrates an embodiment of a system including cache memory 310. System 400 further includes processor 410, main memory 420, memory controller 440, and packetized controller 460. In one embodiment system 400 includes display 430 connected to processor 410. Display 430 may be a display device such as an active matrix liquid crystal display (LCD), dual-scan super-twist nematic display, etc. Lower cost display panels with reduced resolutions and only monochrome display capabilities can also be included in system 400. One should note that future technology flat screen displays may also be used for display 430. In one embodiment processor 410 is a central processing unit (CPU). In another embodiment multiple processors 410 are included in system 400.

Processor 410 is connected to packetized controller 460 including cache memory 310, cache controller 370 and packetized protocol engine 360. In one embodiment packetized controller 460 is a storage device controller. Connected to packetized controller 460 are one or more devices 450. In one embodiment, devices 450 are storage devices. In another embodiment, devices 450 are input/output devices.

Cache memory 310 includes prefetched context segment 330, locked context segment 340 and unlocked context segment 350. In another embodiment cache memory 310 does not include prefetched context segment 330.

Main memory 420 is connected to memory controller 440. In one embodiment main memory 420 can be memory devices such as random access memory (RAM), static RAM (SRAM), dynamic RAM (DRAM), synchronous DRAM (SDRAM), read-only memory (ROM), etc. It should be noted that future memory devices may also be used for main memory 420. In one embodiment context cache controller 370 includes at least one eviction process. In one embodiment packetized protocol engine 360 includes an LRU eviction process. In other embodiments, other eviction techniques are used in the eviction process(es).

In one embodiment prefetched context segment 330, locked context segment 340 and unlocked context segment 350 are separate assigned blocks of addresses in cache memory 310. In another embodiment prefetched context segment 330, locked context segment 340 and unlocked context segment 350 each have different logic values in a field (e.g., a field attached to/associated with an address, etc.). In one embodiment prefetched context segment 330 stores partially protected contexts. The prefetched segment contexts are partially protected because the unlocked segment entries are replaced first. In another embodiment locked context segment 340 enables the transport layer to mark (i.e., assign a logic value or move to a locked partition) a currently used context as locked to prohibit replacement.

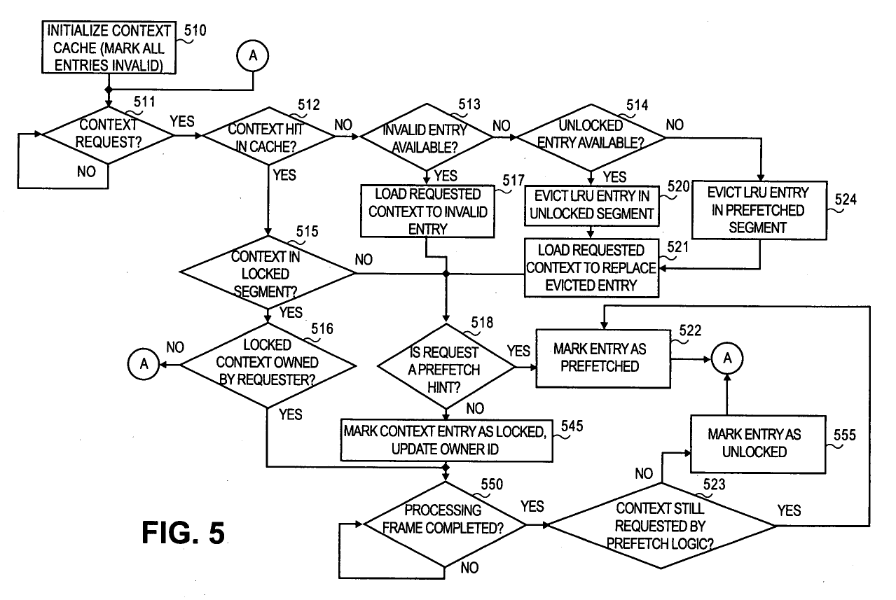

FIG. 5 illustrates a block diagram of a process embodiment. Process 500 begins with block 510 where all cache context entries in a context cache are initialized as invalid. Block 511 determines whether a context request has been received. If block 511 determines that no context requests are received, process 500 continues with block 511 until a context request is received. If block 511 determines that a context request has been received, process 500 continues with block 512.

Block 512 determines if there is a context “hit” in the cache. If block 512 determines there is a hit in the cache, process 500 continues with block 515. In block 515 it is determined if the requested context is in a locked segment, such as segment 340. If block 515 determines that the requested context is in the locked segment, process 500 continues with block 516. Block 516 determines whether a locked context is owned by the agent requesting the context. If block 516 determines that the locked context is not owned by the requesting device, process 500 continues with block 511.

If block 516 determines that the locked context is owned by the requesting device, process 500 continues with block 550. If block 512 determines that there is not a context hit in the cache, process 500 continues with block 513. Block 513 determines if an invalid entry is available. If block 513 determines that an invalid entry is available, process 500 continues with block 517. Block 517 loads the requested context into an invalid entry. Process 500 continues with block 518 where it is determined whether the context request is a prefetch hint. If block 518 determines that the request is a prefetch hint, process 500 continues with block 522. If block 518 determines that the request is not a prefetch hint process 500 continues with block 545.

Block 545 marks the context entry as locked and updates the requested context owner identification. Process 500 continues with block 550 where it is determined whether the processing frame has completed. If block 550 determines that the processing frame has not completed, process 500 continues with block 550 until the frame has completed. If block 550 determines that the processing frame has completed, process 500 continues with block 523.

Block 523 determines whether the context is still requested by prefetch logic. If it is determined that there are no requests for the context, process 500 continues with block 555. Block 555 marks the entry as unlocked and process 500 continues with block 511. If block 523 determines that the context is still requested by prefetch logic, process 500 continues with block 522.

Block 522 marks the entry as prefetched and process 500 continues with block 511. If block 513 determines that there is not an invalid entry available, process 500 continues with block 514. Block 514 determines whether an unlocked entry is available. If block 514 determines that an unlocked entry is available, process 500 continues with block 520. Block 520 evicts an entry in the unlocked segment. In one embodiment, block 520 uses an LRU process to choose the entry to evict. In other embodiment, other eviction techniques can be used. Process 500 then continues with block 521.

Block 521 loads the requested context to replace the evicted context. Process 500 continues with block 518. If block 514 determines that there are no unlocked entries available, process 500 continues with block 524. Block 524 evicts an entry in the prefetched segment of the cache. In one embodiment an LRU process is used for the eviction. In other embodiments, other eviction process techniques are used. Process 500 then continues with block 521.

In one embodiment marking the context entries includes changing a logical state for an associated field of the context entries. In one embodiment the logic states for prefetched contexts, locked contexts and unlocked contexts are each different. In another embodiment marking entries in the cache memory includes partitioning the cache memory into a prefetched context partition, a locked context partition and an unlocked context partition. In this embodiment, when an entry changes from its current state (i.e., prefetched, locked or unlocked) the entry is moved to the appropriate partition.

In one embodiment when the transport layer is ready to use the context “A,” the transport layer reads the context “A” from the cache memory. Context “A” is then moved/marked from the prefetched context segment to the locked context segment. In the case where context “A” is moved, context “A” is physically moved to the appropriate partition. In the case where context “A” is marked, an associated field with the address of the context is modified to the appropriate value associated with the type of context. When the transport layer completes processing of the frame, it updates context “A” and signals the cache memory to release it. If the context is still requested by prefetch logic the context is moved/marked to the prefetched segment. Otherwise, context “A” now moves to the unlocked context segment. Alternatively, if context “A” is read again (by either the same lane or a different lane), it moves back to the locked context segment.

In one embodiment when a context entry needs to be chosen for eviction, the prefetched context segment, the locked context segment and the unlocked context segment provide a basis for choosing the correct entry to replace. In one embodiment the replacement process is as follows. The LRU context entry in the unlocked segment is first to be evicted. If the unlocked context segment is empty, the LRU entry from the prefetched context segment is selected for eviction. Context entries in the locked context segment are never chosen for replacement.

In one embodiment by dividing the cache into three segments, the replacement logic can make intelligent decisions regarding which contexts are still needed by the packetized protocol engine and which context entries can be replaced. In one embodiment the hints from the transport layer or a logic process can be used on either transmit or receive depending on the performance characteristics of the packetized protocol engine.

Some embodiments can also be stored on a device or machine-readable medium and be read by a machine to perform instructions. The machine-readable medium includes any mechanism that provides (i.e., stores and/or transmits) information in a form readable by a machine (e.g., a computer, PDA, cellular telephone, etc.). For example, a machine-readable medium includes read-only memory (ROM); random-access memory (RAM); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

What is claimed is:

1. An apparatus comprising:
a cache memory having a locked segment and an unlocked segment, and
a controller coupled to the cache memory.

2. The apparatus of claim 1, further comprising:
a packetized protocol engine coupled to the cache memory.

3. The apparatus of claim 1, further comprising:
a third segment,
wherein the third segment is a prefetched context segment.

4. The apparatus of claim 3, wherein the first segment, the second segment and the third segment are separate partitions in the cache memory.

5. The apparatus of claim 3, wherein the first segment, the second segment and the third segment are each associated with a context type field.

6. The apparatus of claim 1, wherein the first segment is a locked context segment and the second segment is an unlocked context segment.

7. The apparatus of claim 2, wherein the controller comprises:
eviction logic to only one of the first segment and the second segment.

8. A system comprising:
a processor coupled to a packetized controller including a cache memory, the cache memory including a first context segment, a second context segment and a third context segment; and
a display coupled to the processor.

9. The system of claim 8, the packetized controller further comprising:
a packetized protocol engine coupled to the cache memory; and
a cache controller coupled to the cache memory.

10. The system of claim 8, wherein the plurality of context segments include a prefetched segment, a locked context segment and an unlocked context segment.

11. The system of claim 8, wherein the plurality of context segments are distinct memory blocks in the cache memory.

12. The system of claim 8, wherein the plurality of context segments each have an associated field with different logic values.

13. The system of claim 10, further comprising:
locking logic to prohibit replacement of the locked context segment currently used by a transport layer.

14. A machine-accessible medium containing instructions that, when executed, cause a machine to:
store a first context entry in a cache memory;
store a second context entry in the cache memory, and
store a third context entry in the cache memory if a transport layer completes processing a frame for the entry.

15. The machine-accessible medium of claim 14, wherein
the first context entry is a prefetched context entry, the second context entry is a locked context entry and the third context entry is an unlocked context entry.

16. The machine-accessible medium of claim 14, further containing instructions that, when executed, cause a machine to:
determine if the entry is to be replaced,
if it is determined that the entry is to be replaced:
evict an unlocked context entry from the cache memory if an unlocked entry is available, and
evict a prefetched context entry from the cache memory only if no entries are unlocked contexts.

17. The machine-accessible medium of claim 15, wherein the stored prefetched context entry, the stored locked context entry, and the stored unlocked context entry are each associated with a field having different logic values.

18. The machine-accessible medium of claim 14, the store the prefetched context entry, the store the locked context entry, and the store the unlocked context entry further containing instructions that, when executed, cause a machine to:
change a logical value in an associated field for each context entry, wherein the logical value for the prefetched context entry, the locked context entry and the unlocked context entry are each different.

19. The machine-accessible medium of claim 14, the store the prefetched context entry, the store the locked context entry, and the store the unlocked context entry further containing instructions that, when executed, cause a machine to:
partition the cache memory into a prefetched context partition, a locked context partition and an unlocked context partition.

20. A method comprising:
partitioning a cache memory into a plurality of context segments; and
associating a context entry with at least one of the plurality of context segments if a transport layer completes processing a frame for the context entry,
wherein the at least one segment is an unlocked context segment.

21. The method of claim 20, further comprising:
associating a context entry with at least one of the plurality of context segments if the transport layer is ready to use the context entry,
wherein the at least one segment is a locked context segment.

22. The method of claim 20, further comprising:
associating a context entry with at least one of the plurality of context segments based on a context hint,
wherein the at least one of the plurality of context segments is a prefetched context segment.

23. The method of claim 20, further comprising:
determining if the context entry is to be replaced,
if it is determined that the context entry is to be replaced:
evicting an unlocked context entry if at least one context entry is an unlocked context entry, and
evicting a prefetched context entry only if no unlocked contexts exist within the cache memory.

24. The method of claim 20, further comprising:
associating context entries with the plurality of context segments by a logical state in an associated field, wherein the logical state for each of the plurality of context segments are distinct.

25. The method of claim 20, the partitioning the cache memory into the plurality of context segments comprises:
allocating portions of the cache memory to each of the plurality of context segments.
